(19) United States
(12) Patent Application Publication
(10) Pub. No.: US 2005/0209938 A1
(43) Pub. Date: Sep. 22, 2005

(54) Methods, systems, and articles of manufacture for providing financial accounts with conditions

(76) Inventors: Nathan T. Czyzewski, Arlington, VA (US); Kevin T. Shaffer, Richmond, VA (US); Srishti Kohli, Falls Church, VA (US); Jon Kernkraut, Washington, DC (US); Alihan Hotic, Arlington, VA (US); Shawn Nghiem, Midlothian, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/804,170

(22) Filed: Mar. 19, 2004

(51) Int. Cl. G06F 17/60

(52) U.S. Cl. 705/30; 705/35

(57) ABSTRACT

Methods, systems, and articles of manufacture for providing a benefit credit card products to customers are disclosed. A financial account provider provides a consumer with a benefit financial account that having conditions associated with it to be used to compare against purchase transactions. The financial account provider applying different account parameters to the purchase transactions to the financial account that satisfy conditions associated with the account than it would apply against standard transactions. The financial account has one or more benefit account parameters that include terms that are more beneficial to the customer than terms associated with the standard account parameters. For example, the benefit account parameter may include an interest rate that is lower than the interest rate included with standard account parameters if a customer purchases exceed a certain amount.

### FIELD OF THE INVENTION

This invention relates to financial account products, and more particularly, to systems, methods, and articles of manufacture for providing financial account products with incentives associated with transactions that meet conditions.

### BACKGROUND OF THE INVENTION

Credit card products have become so universally well known and ever-present that they have fundamentally changed the manner in which financial transactions and dealings are viewed and conducted in society today. Credit card products are most commonly represented by plastic card-like members that are offered and provided to customers through financial account providers (such as banks and other financial institutions). With a credit card, an authorized customer or cardholder is capable of purchasing services and/or merchandise without an immediate, direct exchange of cash. With each purchase, the cardholder incurs debt to their credit card account, which the cardholder may thereafter pay upon receipt of a periodic, for example, monthly, statement. In most cases, the cardholder will have the option to either fully pay the outstanding balance or, as a matter of necessity or choice, defer at least a portion or the balance for later payment with accompanying interest or finance charges for the period during which payment of the outstanding debt is deferred (also referred to as a revolving charge credit line).

Credit issuers usually provide general purpose credit cards that may be used for a plurality of different goods and services and with a wide variety of merchants. For example, Visa, MasterCard, and American Express are examples of general purpose credit cards. Since general purpose credit cards are intended for “general use” by a cardholder, they are typically not associated with a single merchant/vendor or limited in use.

Merchants sometimes issue private label credit cards (e.g., a Home Depot Charge Card) for use with that merchant's goods and/or services. These private label credit cards may be issued to a customer of the merchant to provide a benefit to purchase the goods and/or services from that particular merchant. Private label credit cards may be issued with different types of terms and conditions. For example, a private label credit card may include a private label credit line with a predetermined credit limit and the possibility of deferring payment on an outstanding balance with a finance or interest charge (e.g., a revolving credit line). A private label credit card may also include a charge account that requires the cardholder to pay the balance in full at the end of each month or the card may include an installment line of credit where the cardholder is required to make a fixed, periodic payment to the merchant (or the merchant's representative) until the installment debt is paid.

Private label credit cards however, have several disadvantages. For example, the credit line of a private label card may only be used to make purchases in connection with the particular merchant's goods and/or services. As a result a private label credit card limits a customer's overall use of the credit card. Moreover, if the private label credit card includes a charge account that requires full payment of the outstanding balance at the end of the month, the cardholder tends to limit use of the merchant's credit card to an amount that can be paid at the end of the month. Furthermore, because private label credit cards are each only good at usually one merchant, a customer would have to keep track of many different private label credit cards in order to be able to obtain benefits at many different merchants.

### SUMMARY OF THE INVENTION

Accordingly, there is a need for improved methods, systems, and articles of manufacture for providing customers with one financial account by which the cardholder may benefit from certain favorable account terms if the transactions they make meet certain conditions associated with the financial account, while permitting the financial account to also be used as a general purpose credit for purchase transactions that do not meet any of the conditions.

Methods, systems, and articles of manufacture consistent with the principles of the present invention enable a financial account provider, such as a credit card provider, to offer a customer a financial account, such as a credit card account, that is associated with favorable account terms. To provide the favorable account terms, the financial account provider may define at least one condition for the financial account, the condition comprising at least one attribute. The financial account provider may then define a first and second account parameter, wherein the first account parameter is associated with the condition. The financial account provider may then determine whether the transactions associated with the financial account satisfy the condition, the transactions each comprising at least one attribute. Finally, the financial account provider may process transactions that satisfy the condition based on the first account parameter and process other transactions based on the second account parameter. In one configuration consistent with certain principles related to the present invention, the first and second account parameters may be different finance fees, such as interest rates, that are applied to the respective transactions.

It is to be understood that both the foregoing general description and the following detailed description are exemplary and explanatory only and are not restrictive of the invention, the scope of which is to be measured from the claims. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments of the invention and together with the description, serve to explain the principles of the invention. In the drawings:

FIG. 1 is an illustration that demonstrates an exemplary processing of transactions to a credit card account, consistent with the principles of the invention;

FIG. 2A illustrates a block diagram of an exemplary financial account system consistent with the present invention.

FIG. 2B illustrates a block diagram for collecting information consistent with the present invention;

FIG. 2C illustrates an exemplary financial account provider computer system consistent with the present invention;

FIG. 2D illustrates an exemplary system environment in which certain features and principles related to the present invention may be implemented;

FIG. 3 is a flowchart of an exemplary process for offering credit card products to target customers, in accordance with certain principles related to the present invention;

FIG. 4 is a flowchart of an exemplary process to set up a financial account, consistent with certain embodiments of the present invention;

FIG. 5 is a flowchart of an exemplary account condition set up process, consistent with certain embodiments of the present invention;

FIG. 6 is a flowchart of an exemplary account parameter set up process, consistent with certain embodiments of the present invention;

FIG. 7 is a flowchart of an exemplary transaction process, consistent with certain embodiments of the present invention; and

FIG. 8 is a flowchart of an exemplary transaction match process, consistent with certain embodiments of the present invention; and

FIG. 9 is a flowchart of an exemplary transaction expiration process, consistent with certain embodiments of the present invention; and

FIG. 10A is an exemplary billing statement, consistent with certain embodiments of the present invention; and

FIG. 10B is a second page of an exemplary billing statement, consistent with certain embodiments of the present invention.

### DESCRIPTION OF THE EMBODIMENTS

Reference will now be made in detail to the present exemplary embodiments of the invention, examples of which are illustrated in the accompanying drawings. Wherever possible, the same reference numbers will be used throughout the drawings to refer to the same or like parts.

Generally, the present invention is directed to systems, methods, and articles of manufacture for managing a credit card account associated with certain conditions chosen by the financial account provider. In accordance with one configuration consistent with certain principles related to the present invention, target customers may be initially presented with offers for obtaining a credit card product, for example a benefit credit card. As used herein, a benefit credit card is a credit card that is associated with different benefits available to the user such as for example, lower interest rate or no monthly fee. These offers may be presented through any type of solicitation technique, such as conventional direct mail, newspaper ads, and web page advertisements. The credit card product may include a general purpose line of credit associated with “standard account parameters” including “standard account terms,” such as a determined credit limit and a standard interest rate. The credit card product may also be associated with one or more “benefit account parameters” including “benefit account terms” that vary from the standard credit terms, such that they are more favorable to the customer. For example, a benefit account parameter may include an interest rate that is lower than an interest rate included in the standard account parameter. In one embodiment, a benefit account parameter may include an interest rate that is higher than an interest rate included in the standard account parameter. The benefit account parameter may also include a monthly payment waiver period, an interest rate waiver period, or a payment allocation option. The benefit account parameter may then be applied to transactions that meet certain conditions defined by the account provider prior to issuing the benefit credit card product. While features of the present invention may be described herein in the context of the financial account being a credit card account, the present invention may be used for other types of financial accounts, such as debit cards and check cards.

In one configuration consistent with the principles related to the present invention, a financial account provider may process a customer's billing statement based on different conditions set up by the financial account provider. For example, a customer's benefit credit line may have a single credit limit that is adjusted based on, but not limited to, purchase transactions associated with particular merchants' names, merchant locations, merchant types, transaction times, transaction dates, and transaction amounts. Finance charges however, may be processed separately for set of transactions based on the standard and benefit credit parameters. In one configuration consistent with the principles related to the present invention, purchase transaction that meet certain conditions associated with a credit card be processed at a lower interest rate than purchase transactions that do not meet any conditions.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The program instructions may be those specially designed and constructed for the purposes of implementation of the invention, or they may be of the kind that are well-known and available to those having skill in the computer software arts. Examples of program instructions include, for example, machine code, such as produced by a compiler, and files containing a high level code that can be executed by the computer using an interpreter.

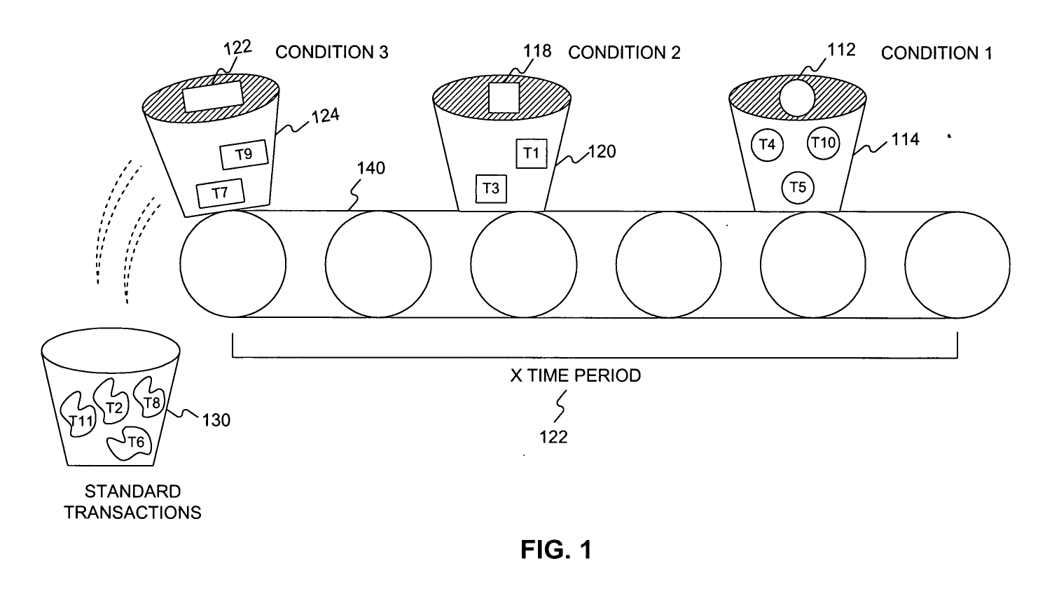

FIG. 1 is an illustration that demonstrates an exemplary processing of transactions to a credit card account, consistent with the principles of the invention. The buckets and conveyer belt that are illustrated in this drawing are not real buckets or real conveyer belts, they are merely stylized analogies to assist in explaining the principles of the invention. As shown in FIG. 1, a financial account provider may process a set of purchase transactions T1-T11 after the user completes the transaction at the merchant site. Representational buckets 114, 120, and 124 represent repositories for the different conditions that are associated with the credit card account. The opening 112, 118, and 122 at the top of each bucket represents the conditions associated with each bucket. If a transaction meets the condition, then the bucket will hold the transaction. In this exemplary embodiment, the credit card account is associated with condition 1 (112), condition 2 (118), and condition 3 (122). Once a user makes a transaction, the transactions may be compared against all three conditions and if neither of the three conditions are satisfied, the transaction falls into a standard bucket 130. Transactions T1-T11 are all of the purchase transaction within the current billing cycle 112. For example, once a transaction is in a bucket 124 for having satisfied the condition for that bucket, the bucket 124 moves down a conveyer belt 140. The belt 140 is an analogy for an amount of time set by the financial account provider. Once the time period 122 has expired for a bucket 124 for example, the bucket 124 moves down the belt and the transactions stored in the bucket 124 are then transferred to the bucket 130 storing standard transactions.

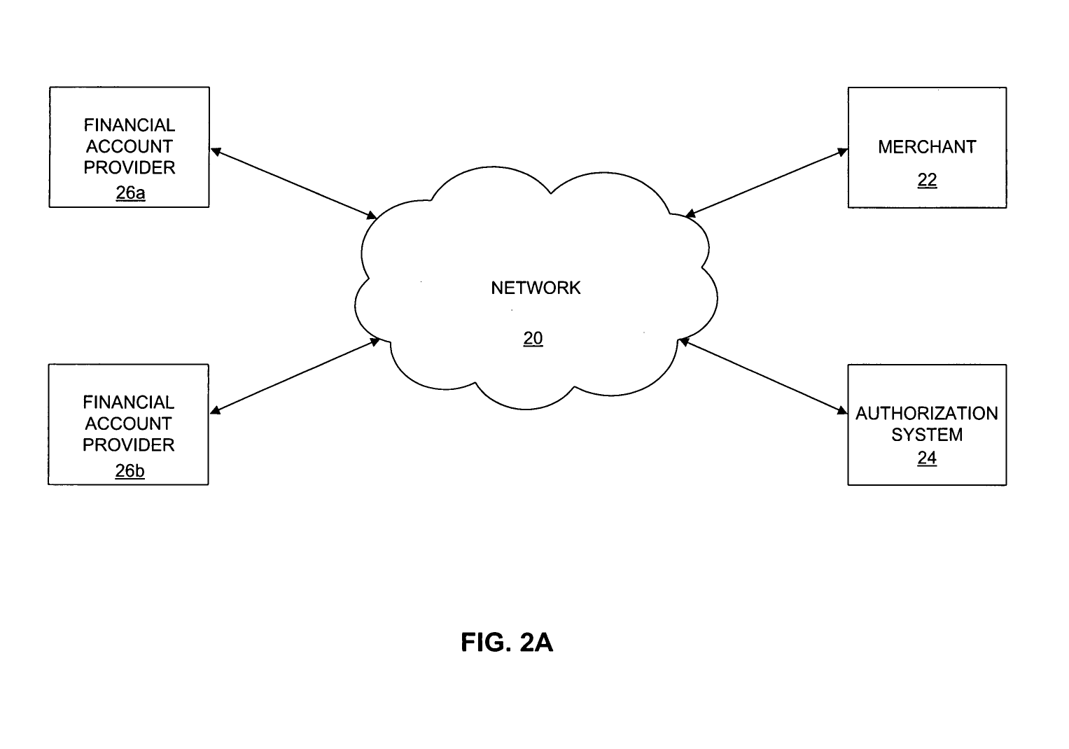

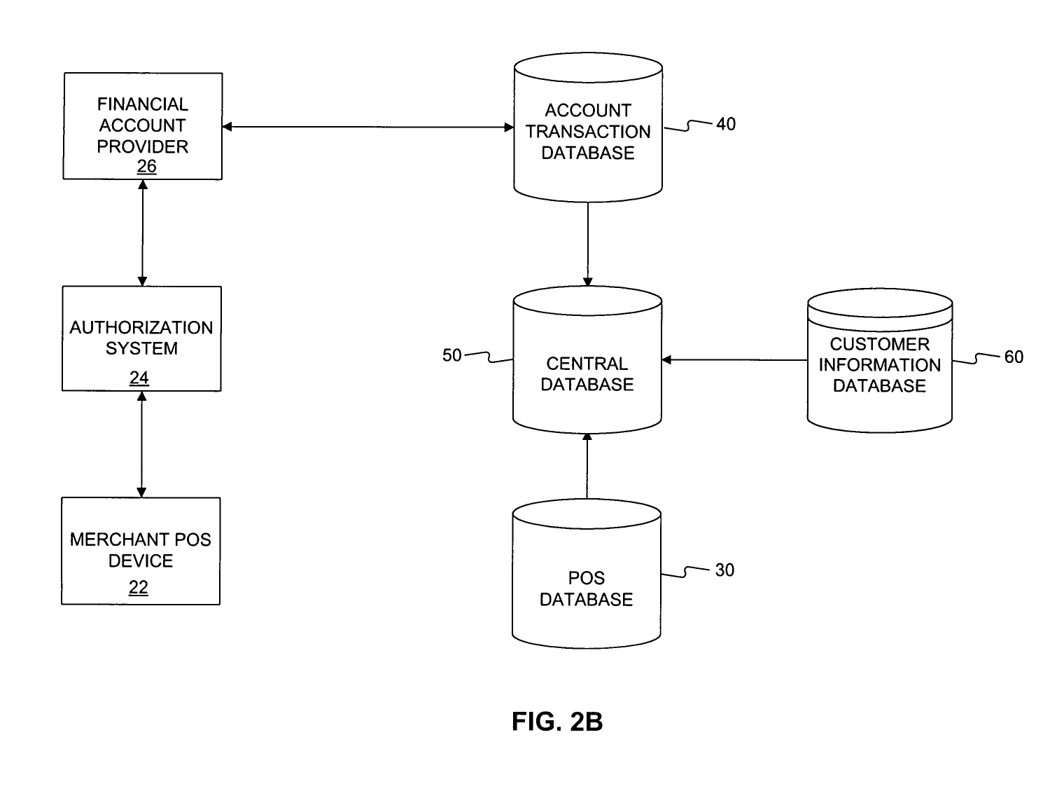

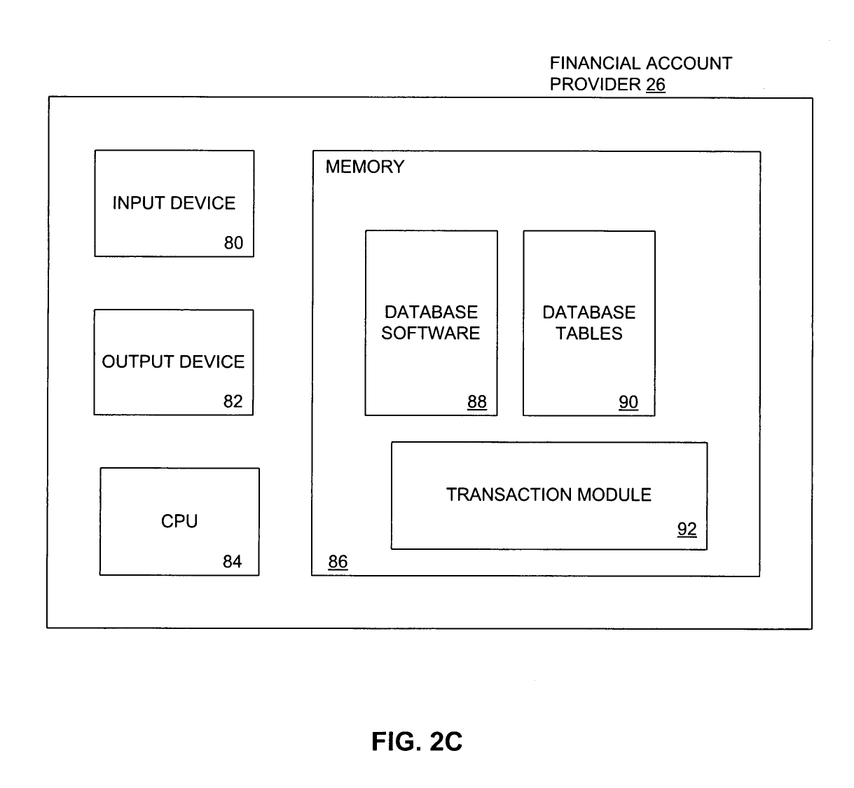

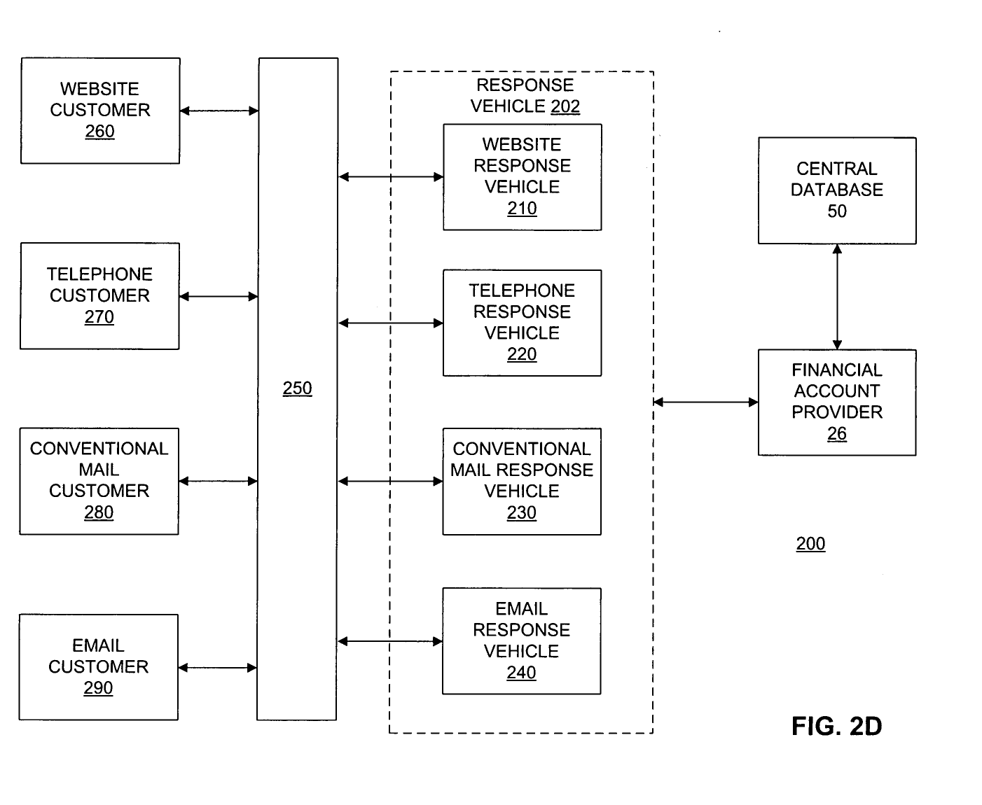

FIG. 2A illustrates a block diagram of an exemplary financial account system consistent with the present invention. As shown in FIG. 2A, a merchant 22 may be connected via network 20 to an authorization system 24. Financial account providers 26a and 26b may also be connected to merchant 22 and authorization system 24 via network 20. Although two exemplary financial account providers are shown in FIG. 2A, a financial account system may have one or more financial account providers. A financial account provider 26 may include a computer system (FIG. 2C) that performs one or more processes consistent with embodiments of the present invention. Network 20 may comprise any type of computer networking arrangement used to exchange information. For example, network 20 may be the Internet, a private data network, or a virtual private network which may or may not use a public network such as the Internet. Network 20 may also include a public switched telephone network (PSTN) and/or a wireless network. Merchant 22 may represent any number of merchants that provide goods or services in exchange for payment via a particular payment system. For example, merchant 22 may be an online retail merchant, a traditional brick-and-mortar retail merchant, or any other type of merchant of goods or services. Each merchant 22 may communicate directly or indirectly with authorization system 24 in order to initiate the process of obtaining payment. Authorization system 24 may be, for example, the Visa or Master Card networks or any other clearing house for approval of transactions.

FIG. 2B illustrates an exemplary process for collecting data used to create purchase records. During a typical purchase transaction, a customer may swipe a financial account card, such as a credit card, at a merchant location as a form of payment for the purchase transaction. A point of sale device, such as a credit card terminal, located at merchant 22, for example, may then transmit a request to authorization system 24 to determine whether the financial account provider will authorize the purchase transaction. Authorization system 24 may be, for example, the Master Card/Visa interchange network or any other comparable interchange network for processing purchase transactions. Authorization system 24 may then forward the authorization request to financial account provider 26, which may then determine whether to authorize the purchase transaction.

Financial account provider 26 may respond to the authorization request by forwarding the appropriate response to the merchant. As described herein, financial account provider 26 may be operated by an issuing bank associated with a financial account, or may be operated by any other entity or entities. Assuming the authorization request is approved, the merchant may then store information concerning the completed purchase transaction in a point of sale (POS) database 30. As explained below with respect to FIG. 2B, POS database 30 may store merchant records including data associated with each particular transaction.

When authorizing a purchase transaction, financial account provider 26 may match a customer account number associated with the transaction (e.g., the credit card number) with a transaction approval number, which may be any numerical or alpha-numeric character string uniquely identifying the particular transaction. Financial account provider 26 may store the data associated with the purchase transaction in an account transaction database 40. As explained below, account transaction database 40 may store account transaction records associated with multiple purchase transactions between a number of customers and merchants.

In one embodiment, financial account systems consistent with the present invention may also combine the merchant records from POS database 30 and the purchase transaction data from account transaction database 40 to form purchase records stored in a central database 50. The stored purchase records may further include data obtained from a customer information and demographic database 60 (demographic database).

Information stored in demographic database 60 may be obtained from several different sources. For instance, demographic database 60 may include customer information obtained by a financial account provider during the credit card application process. Such customer information may include, for example, the name, address, income, and other relevant information of the account holder. Demographic database 60 may further include demographic information or attributes, such as information obtained from census databases. Demographic information may be obtained by mapping customer information, for example, the name and address of a customer, onto a census database. Additionally, demographic database 60 may also include geographic information, such as postal code information, Zip code information, address information, GPS information, longitude/latitude information, and other global positioning information that might be useful in pinpointing a location of a customer or a merchant.

FIG. 2C is a block diagram illustrating an exemplary computer system of a financial account provider 26, consistent with the principles of the present invention. Financial account provider 26 may include any general-purpose computing system, such as a mainframe computer, a multi-processor UNIX system, or a powerful PC-based server system. In any case, such a system may have at least one input device, such as an input device 80. Possible input devices include network interfaces, keyboards, mice, speech recognition devices, or document, video, or image input devices. Additionally, financial account provider 26 may have at least one output device 82, such as for example, display devices, network interfaces, printers, or sound or speech output devices.

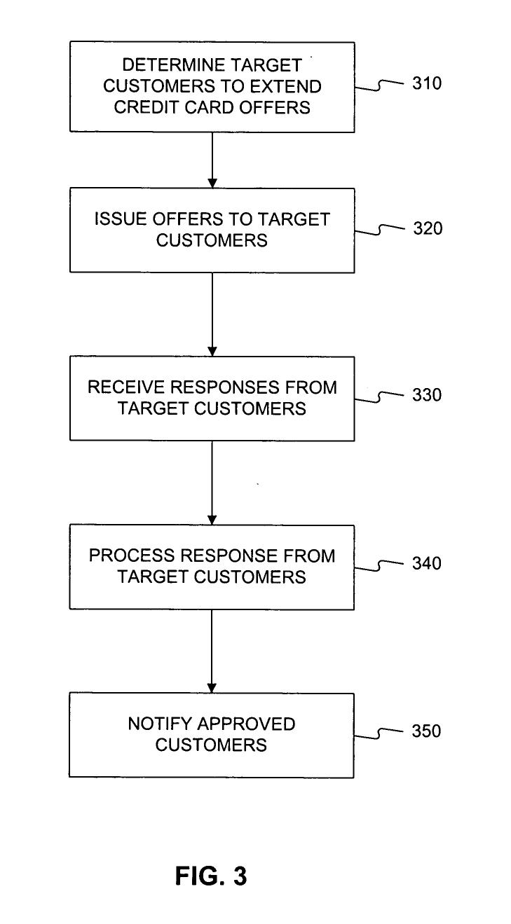

As illustrated in FIG. 2C, financial account provider 26 may also include at least one central processing unit (“CPU”) 84. CPU 84 may execute software programs for implementing the processes described below with respect to FIGS. 3-9. One skilled in the art will appreciate that, although FIG. 2C shows one CPU, multiple CPUs may execute the aforementioned software programs. These software programs may reside in memory 86 of financial account provider 26. For instance, memory 86 may include database tables 90 comprising records, such as account transaction records, merchant records, and purchase records, and software 88 for manipulating the records of database tables 90.

In one embodiment, software 88 may interact with various modules (described below) stored in memory 86 to process records stored in database tables 90. Thus, for example, software 88 may be relational database software which may interface with any software module or program that may query, sort, segment, or generate financial account reports by processing purchase records stored in database tables 90. One skilled in the art will appreciate that any object oriented techniques or other computational techniques may also be used consistent with the present invention to manipulate records stored in database tables 90. Indeed, based on object oriented techniques, records stored in database tables 90 may be represented as objects and may not be stored as part of any table. In other words, database tables 90 and software 88 are merely exemplary, and records, or equivalents thereof, may be processed using other known computing techniques and arrangements.

One skilled in the art will appreciate that the data of database tables 90 and the processes implemented by software 88 may be combined or distributed in any manner consistent with the present invention. Indeed, database tables 90 and database software 88, and transaction module 92 may be stored in any combination of memories, such as those located in a distributed computing network, and thus need not be located on the same computer system.

Memory 86 may further include transaction processing modules 92. These modules when executed by CPU 84 for example, provide the functionality associated with the flow charts of FIGS. 3-9 described below. Each of these modules may be implemented in at least one of software, firmware, hardware, or any combination thereof. The modules may be combined in any fashion and may be located on the same system or implemented across a distributed computing system.

FIG. 2D illustrates an exemplary system environment 200 in which the features and principles of the invention may be implemented. As illustrated in FIG. 2D, the system environment 200 includes a plurality of customers (260-290), a response vehicle 202 including a plurality of different response vehicles (210-240), a financial account provider 26, a central database 50, and a communications channel 250.

Each customer in system environment 200 is associated with a different customer category. For instance, customers 260 may be website customers that access and retrieve information through an Internet website. This website may be a branded website that is operated by one or more vendors, or may be a website operated by the financial account provider. Customers 270 may be telephone customers that access and receive information using conventional telephonic communication techniques and systems. This includes, for example, wireline and wireless telephony systems. Customers 280 may be conventional mail customers that access and receive information by conventional mail techniques and services. This includes, for example, customers that are part of a financial account provider's mailing list. Finally, customers 290 may be customers that access and receive information using electronic mail (Email) services. Customers 260-290 may also represent entities (such as an individual, a group of individuals, corporate entities, or any combination thereof), that hold credit card accounts with the financial account provider 26. The categories of customers illustrated in FIG. 2D are exemplary and should not be considered limiting. For example, a variety of different customer categories may also be implemented in environment 200, such as customers using kiosk computers, personal digital assistants (PDAs), or using wireless hotspots.

Response vehicle 202 represents a system for handling communications between the customers 260-290 and financial account provider 26. Response vehicle 202 may be part of a financial account provider's network and, as shown in FIG. 2D, include a plurality of response vehicles 210-240 that correspond to different category groups of customers 260-290. Each response vehicle is responsible for handling communications to and from a particular customer. For example, website response vehicle 202 may handle Internet related communications, such as web based transactions, between customer 260 and financial account provider 26. Telephone response vehicle 220 may handle telephonic communications between the customer 270 and financial account provider 26. Thus, in the event financial account provider 26 wishes to solicit customers telephonically, response vehicle 202 includes the necessary systems to support such operations. Response vehicle 230, on the other hand, includes the necessary systems and organizations to handle conventional mail processing to and from customer 280. Response vehicle system 240 includes the necessary systems and organizations to process electronic mail transactions with customer 290. Response vehicle 202 may receive responses from the customers and forward them to financial account provider 26 for appropriate processing. Notifications to the customers also are performed from financial account provider 26 to the customers through response vehicle 202.

Communication channel 250 facilitates communications between the various customer(s) and response vehicle system 202 illustrated in FIG. 2D. Such communications may include communications related to offering and issuing lines of credit for existing credit cards. Communications channel 250 may include, for example, a telephony-based network, a local area network (LAN), a wide area network (WAN), a dedicated intranet, the Internet, and/or a wireless network. Further, any suitable combination of wired and/or wireless components and systems may be incorporated into communications channel 250. Any suitable combination of point-to-point communications or networked communications may also be incorporated into communication channel 250 to facilitate communication between the different entities illustrated in FIG. 2D. Moreover, any part of communication channel 250 may implemented through traditional infrastructures or channels of trade, to permit operations associated with the extra credit offers to be performed manually or in-person by the various entities illustrated in FIG. 2D.

Financial account provider 26 receives communication information from response vehicle 202 and may process it using central database 50. Database 50 may contain various information including credit information, potential customer lists, risk scores for potential and current customers, approved customers, credit limits for approved customers, vendor tables including merchant identification numbers, customer information, purchase information, authorization information, and/or settlement information. Financial account provider 26 also sends information to response vehicle 202 for delivery to the appropriate customers. Financial account provider 26 is responsible for providing various credit cards and establishing associated accounts. Financial account provider 26 may include one or more of the following: a bank, an acquiring bank, a merchant bank, a merchant or any commercial institution capable of providing a credit card consistent with the features disclosed herein. Further, although FIG. 2D only illustrates one financial account provider 26, it is of course possible that more than one financial account provider be provided in system environment 200.

FIG. 3 illustrates an exemplary process associated with soliciting offers and processing responses for benefit credit lines from credit card customers. According to an aspect of the invention, to issue lines of credit to potential customers, financial account provider 26 may identify specific target customers to receive a benefit credit line offer (Step 310). To evaluate and identify target customers, several factors may be considered by the financial account provider 26. Such factors may be based on credit information received from one or more credit information sources (i.e., sources that provide credit information to financial account provider 26). Credit information may also be provided to financial account provider 26 when customers respond to credit card offers from is the provider 26. Moreover, credit information may be requested by financial account provider 26 when determining a target customer group to extend offers. Credit information may include credit history information and/or personal information (e.g., income, employment status, etc.) that is used when evaluating a customer's credit rating or worthiness. Credit information sources may comprise a commercial credit information source (such as TRW/Experian, Equifax and TransUnion or a similar commercial credit service bureau) and/or private credit information services.

The credit information is analyzed to determine the credit worthiness or a level of risk associated with each target customer. If a customer's credit worthiness satisfies predetermined credit criteria, then financial account provider 26 may approve the customer for inclusion in a target customer group. The target customer group includes all identified customers that financial account provider 26 will extend offers to for a benefit credit card product.

In accordance with the principles related to the present invention, the benefit credit card product may be associated with a general purpose line of credit, but also associated with a specific conditions defined by the financial account provider. These conditions may be based on merchant name, merchant type, merchant location, transaction date, transaction time, and transaction amount. For example, the benefit credit card can have as a condition defined as “any purchase over $99.00 will receive no finance charges for four billing cycles,” or a condition defined as “any purchase from a grocery store in Georgia will have no monthly payments due for three billing cycles.” In general, cardholders may make purchases from merchants using benefit credit card products consistent with certain principles related to the present invention.

Once financial account provider 26 has identified a target group of customers (which may then be stored in central database 50) it generates offers for these selected customers. The offers may vary for each customer based on the credit worthiness determined in Step 310 (see FIG. 3). That is, a customer with a high credit risk may be offered a product having a credit line with a relatively low available limit (e.g., $500). Another customer with a lower credit risk may be offered a line of credit with a relatively high available limit (e.g., $5000). The options available to the financial account provider 26 may extend beyond these options as well, and one skilled in the art would realize that the present invention is not limited to the above examples.

Once the offers are generated, they are sent to response vehicle 202 for distribution to the customers (Step 320). Each response vehicle in vehicle 202 processes the offers in order to provide them to the customers through any appropriate medium or communication channel. Once each response vehicle has processed the offers, they are sent to the specified customers for response. Customers 260-290 may respond (accept or decline) to the offers using the medium associated with their category. The responses are sent back to response vehicle 202 (Step 330), where they are processed for presentation to financial account provider 26 (Step 340).

Based on the category of a customer, responses may or may not be processed immediately. For instance, responses may be received and processed instantaneously for customers 260 and 270, while responses from customers 280 may be delayed. For example, suppose a customer 260 using a personal computer, views a website operated by financial account provider 26. The site may include a designated page that is presented to the customer that displays the offer determined by financial account provider 26. The customer may decide to accept or decline the offer by merely selecting an icon representing their choice, and perhaps providing credit information through the website. The response is then sent back to response vehicle 202. Response vehicle 202 processes the response and prepares it for presentation to financial account provider 26. The response is processed at financial account provider 26 and a notification may be sent back to customer 260, through response vehicle 202 (Step 350). The notification may indicate to the customer that their response to an offer has been processed and whether or not a benefit credit card was approved. The notifications may be displayed through a webpage that the customer was viewing when the offer was presented or on a separate webpage. In one configuration consistent with the present invention, the customer may check the webpage to receive the notification. Alternatively, financial account provider 26 may provide an e-mail to the customer including the notification or a message indicating to the customer to check a particular Website to receive the notification.

As can be seen, a customer who has accepted an offer through a website may receive immediate notification of an approval for a benefit credit card provided by credit card provider 26. On the other hand, a customer who has been solicited by conventional mail, such as customer 280, may respond to the offer by mailing back an acceptance and application form to the card issuer. The response form may be received and processed by response vehicle 202, and eventually processed by financial account provider 26. Notification of an acceptance by financial account provider 26 may then be sent back to the customer using the same conventional mail process.

There may be a plurality of variations available to financial account provider 26 when communicating with customers. That is, a mail customer 280 may wish to respond by telephone or through a website. Additionally, customers may respond by one medium, and request notification by another. For instance, a customer 280 who has received an offer in the mail, may respond by mail, yet request notification by email. Accordingly, a variety of user friendly options are available to customers for receiving and responding to the offers presented by financial account provider 26. The above descriptions are for illustrative purposes alone and should not be viewed as limitations to the present invention. One of ordinary skill in the art would realize that any number of combinations of communication techniques may be implemented without departing from the principles of the present invention.

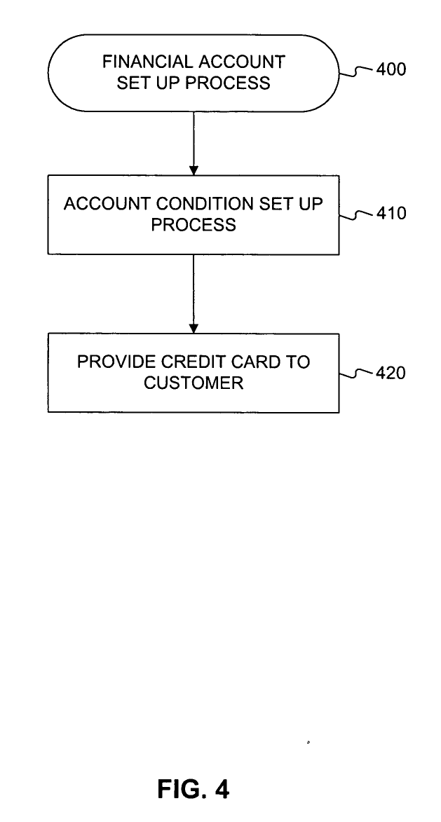

FIG. 4 illustrates a flowchart of an exemplary process that may be performed by financial account provider 26 when setting up a financial account. Initially, financial account provider 26 may configure a new financial account for the user, or reconfigure an existing account managed by the financial account provider 26. Financial account provider 26 configures the financial account by initially setting up the account conditions (Step 410) that are specific to each account that the financial account provider 26 creates. Financial account provider 26 may set up as many conditions as desired associated with one account. Financial account provider 26 may then compare each purchase transaction that a user makes against the financial account with these conditions. If the financial account provider 26 determines that one or more purchase conditions are satisfied, the customer will be awarded beneficial account terms towards those transactions. Once the financial account provider 26 defines the one or more condition to be associated with the financial account, the financial account provider 26 provides the credit card to approved customers (Step 420) and sends them the credit card.

For exemplary purposes only and to illustrate embodiments of the transaction process, financial account provider 26 may issue a benefit credit card with a condition with two attributes in accordance with Table 1, a second benefit credit card with a condition with one attribute in accordance with Table 2, and a benefit third credit card with a condition with two attributes in accordance with Table 3. Alternatively, financial account provider 26 may issue a benefit credit card that is associated with condition 1, condition 2, and condition 3. It is understood, however, that the financial account provider 26 may define any number of conditions with any number of attributes and any number of parameters over any period of time to any number of benefit credit cards, and that the condition attributes and the parameters listed in Tables 1, 2, and 3 are not intended to be limiting.

TABLE 1
Exemplary Condition 1
Condition: 1

| | Class | Value |
|---|---|---|
| Attribute 1 | transaction amount | >$99.00 |
| Attribute 2 | merchant location | = Georgia |
| | Type | Time Period |
| Parameter 1 | Finance Charge Waiver | 6 months |
| Parameter 2 | Minimum Monthly Payment | 6 months |
| | Waiver | |

TABLE 2
Exemplary Condition 2
Condition: 2

| | Class | Value |
|---|---|---|
| Attribute 1 | transaction amount | >$599.00 |
| | Type | Time Period |
| Parameter 1 | Finance Charge Waiver | 4 months |

TABLE 3
Exemplary Condition 3
Condition: 3

| | Class | Value |
|---|---|---|
| Attribute 1 | transaction period | = Wednesday |
| Attribute 2 | merchant type | = grocery |
| | Type | Time Period |
| Parameter 1 | interest rate 1% | 4 months |
| Parameter 2 | Minimum Monthly Payment | 4 months |
| | Waiver | |

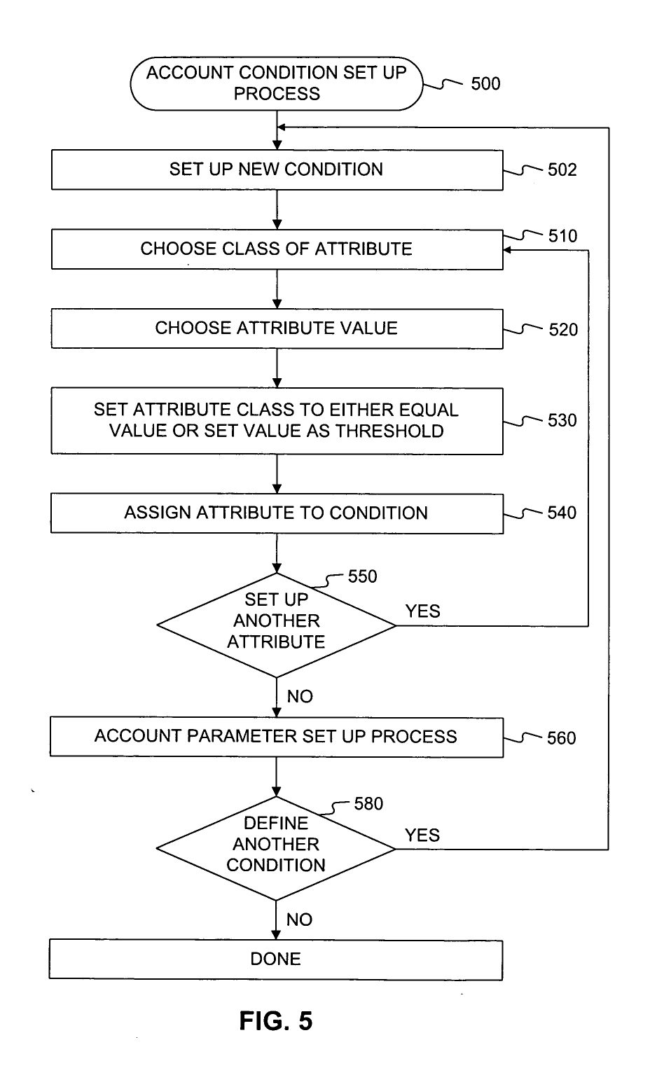

FIG. 5 illustrates a flowchart of an exemplary account condition set up process for implementing step 410 of FIG. 4. For exemplary purposes and only to illustrate embodiments of the condition set up process, reference will be made to Tables 1, 2, and 3. Financial account provider 26 may first decide to set up a new condition (Step 502) to be associated with the benefit credit card. Financial account provider 26 may then choose an attribute (Step 510) to be associated with a first condition that may be issued as part of a credit card agreement. For example, in Table 1, financial account provider 26 has defined two attributes to be associated with condition 1. Financial account provider 26 may first choose the class of the attribute selected from but not limited to, a merchant name, merchant type, merchant location, transaction date, transaction time, and transaction amount (Step 510). For example, in Table 1, the first attribute class is “transaction amount.” After financial account provider 26 defines an attribute class, it may then set an attribute value (Step 520) to be associated with the attribute class. This value may differ depending on what the financial account provider 26 chose for the attribute class. For example, if the financial account provider 26 chose as the attribute class “transaction amount,” then the attribute value may be a numeric amount. However, if the financial account provider 26 chose as the attribute class either “merchant name,” “merchant type,” or “merchant location,” the attribute value associated with each of these may be a text value. Furthermore, if the financial account provider 26 chose “transaction time” for the attribute class, then the attribute value may be in a date format listing the month, day, and year, or may be the name of a month, or the name of a day in the week. After the financial account provider 26 selects a value for the attribute, the financial account provider 26 must determine whether to set the class to equal the value or whether the value will be treated as a threshold (minimum or maximum) (Step 530). This determination may be based again on the type of value that the financial account provider 26 chose. For example, in Table 1, Attribute 1 class is “transaction amount,” and the attribute value is “$99.00.” In this example, the “transaction amount” is set to be “greater than” the attribute value of “$99.00” and therefore “$99.99” is a minimum threshold. After the financial account provider 26 has defined one attribute for the condition, it may assign the attribute to the condition (Step 540). The financial account provider 26 may then choose to set up another attribute for the same condition (Step 550). The options available to the financial account provider 26 may extend beyond these options as well, and one skilled in the art would realize that the present invention is not limited to the above examples.

For example, condition 1 in Table 1 has two different attributes associated with it. Attribute 2 has an attribute class of “merchant location,” and an attribute value of “Georgia.” Financial account provider 26 in this example set the attribute class “merchant location” to equal the attribute value “Georgia.” Alternatively, financial account provider 26 may have chosen a country, city, or county as the attribute value of a “merchant location.” The financial account provider 26 may select as many attributes as desired and the financial account provider 26 is not limited to only choosing one. If the financial account provider 26 does not to set up another attribute for the condition, it may then define the account parameters that are associated with the condition (Step 560). After the financial account provider 26 defines the account parameters, it may define and set up another condition (Step 580) and the financial account provider 26 would then proceed to set up a new condition (Step 502).

For exemplary purposes, financial account provider 26 may choose another set of attributes for another condition. Table 2 illustrates a second exemplary condition in accordance with aspects of the present invention. In this example, condition 2 has only one attribute. The attribute class is “transaction amount” and the attribute value is “$599.00.” The financial account provider 26 has defined the “$599.00” to be a minimum threshold and therefore the complete attribute is “transaction amount>$599.00.” In the last example in Table 3, condition 3 has two attributes. The first attribute has an attribute class of “transaction period” and has an attribute value of “Wednesday.” Alternatively, the transaction period may have been but not limited to a year, month, or entire date including year, month, and day.

Condition 3 also has a second attribute that has an attribute class of “merchant type,” and an attribute value of “grocery.” The attribute value associated with the attribute class “merchant type” can be one of many different merchant types. For example, the attribute value could be, but not limited to automotive, restaurant, fast food, clothing, beverage, airline, etc. One skilled in the art would realize that the manner by which financial account provider 26 defines the conditions is not limited to the above examples, and other techniques may be implemented without departing from the spirit and scope of the present invention.

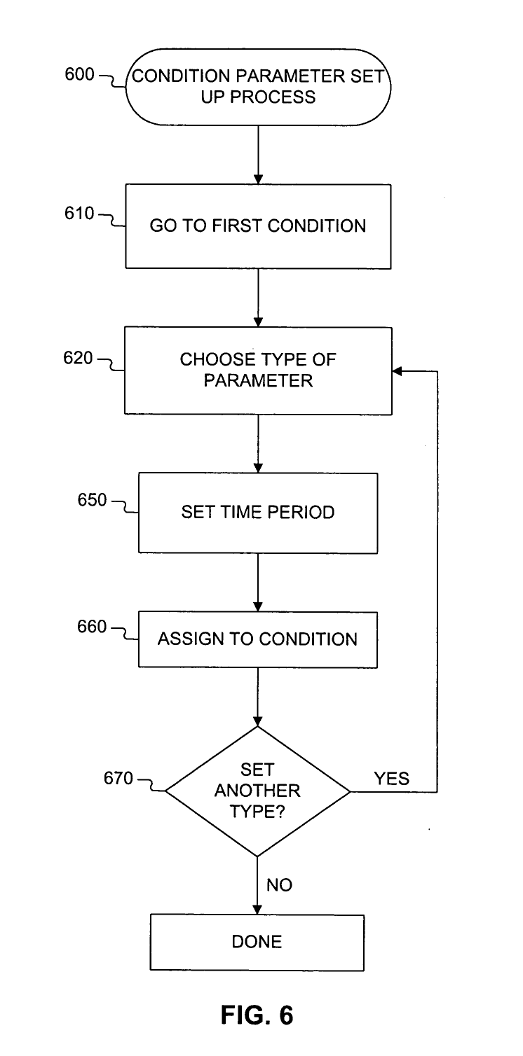

FIG. 6 illustrates a flowchart of an exemplary condition parameter set up process for implementing step 560 of FIG. 5. Financial account provider 26 may set up various account parameters for each condition that it has defined. First, the financial account provider 26 may, after choosing the first condition (Step 610), define the type of account parameter to assign to the condition (Step 620). For example, financial account provider 26 may choose from a list containing, but not limited to, “interest rate,” “minimum monthly payment wavier,” “interest rate waiver,” or “payment allocation.” In one configuration, depending on the type the financial account provider 26 chose, a value may need to be assigned to the type. For example, if the financial account provider chose “interest rate,” then the financial account provider may set a rate for the “interest rate” account parameter. After the financial account provider 26 defines the type of parameter to be associated with the condition, the financial account provider 26 may then choose a time period to associate with the type (Step 650). This time period could be, but is not limited to, a length in years, months, days, weeks, hours, or billing cycles. After the financial account provider sets the account parameter time period to be associated with the account parameter type, the financial account provider 26 may assign the account parameter to the condition (Step 660). After the account parameter has been assigned to the condition, the financial account provider 26 may decide to assign another account parameter to the condition. If the financial account provider 26 decides to assign another account parameter (Step 670), the financial account provider 26 may again define another type and time period in accordance with the invention. A condition may have many account parameters associated with it. One skilled in the art would realize that the manner by which financial account provider 26 defines the account parameters is not limited to the above examples, and other techniques may be implemented without departing from the spirit and scope of the present invention.

Once the conditions of the financial account are defined, the conditions are associated with a newly created benefit credit line for the customer (Step 430). The new benefit credit line may be added to the credit information maintained in central database 50. The new benefit credit line may be formatted in central database 50 as the other credit lines associated with the other customers of financial account provider 26.

In one configuration consistent with the principles related to the present invention, the customer's benefit credit line may include a standard credit parameter including a single credit limit that is adjusted based on purchase transactions made with the benefit credit card, including those transactions that meet the conditions associated with the benefit credit card. Also, the standard credit parameter information may include a standard credit term, such as an interest rate that may be applied by financial account provider 26 to purchase transactions that do not satisfy any of the conditions that are associated with the benefit credit card. Additionally, the benefit credit line may also be associated with one or more benefit credit parameters including a benefit credit term, such as benefit interest rate that may be applied by financial account provider 26 to purchase transactions that satisfy the conditions that are associated with the benefit credit card. Alternatively (or in addition to the benefit interest rate term), the benefit credit line may include a benefit credit parameter including a term that indicates to financial account provider 26 to waive selected finance fees associated with the benefit credit line if the attributes of the conditions that are associated with the card are satisfied. For example, the benefit credit card could be associated with a condition that states that “if transactions exceed $99.00, then for four months no interest will be due on those transactions.” Alternatively, financial account provider 26 may define a condition associated with the benefit credit card that “any transaction in Georgia will have no minimum monthly payment due for five months.” Further, the standard and benefit credit parameter information may reflect any account term that is more favorable to the customer for purchases that satisfy the conditions associated with the benefit credit card. One skilled in the art would realize that the format and type of information maintained in central database 50 may vary without affecting the spirit and scope of the present invention.

Once the benefit credit line is added to central database 50, financial account provider 26 may generate a benefit credit card product and provide it to the customer via response vehicle 202 (Step 420). Also, the customer may be provided with information associated with their new benefit credit line account, such as available balance, terms, and benefits.

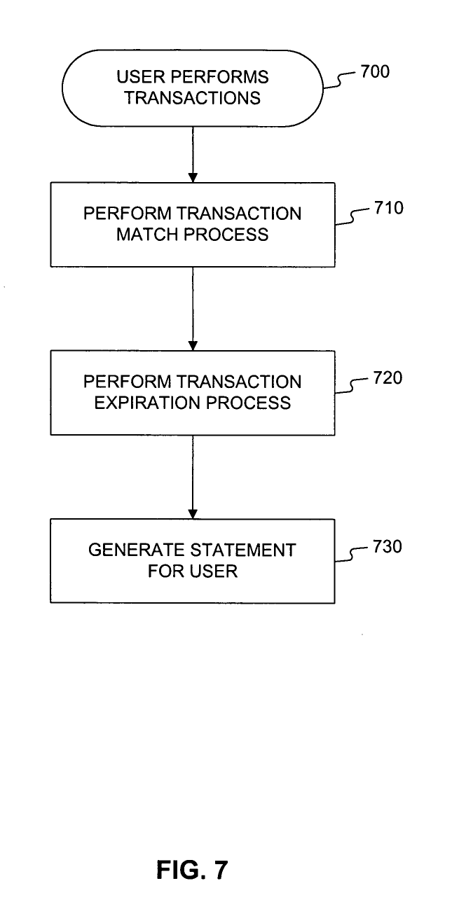

FIG. 7 is a flowchart of an exemplary process, consistent with certain embodiments of the present invention. A customer, after being offered the benefit credit card (Step 420) may perform transactions (Step 700) using at least one financial account. For exemplary purposes only and to illustrate embodiments of the incentive transaction process, the user may purchase goods and/or services using the benefit credit card managed by the financial account provider 26 as summarized in Table 4. It is understood, however, that the user may perform any number of transactions over any period of time, and that the transactions listed in Table 1 are not intended to be limiting.

TABLE 4
Exemplary Transactions

| Transaction | Transaction | Transaction | Merchant | Merchant | Merchant |
|---|---|---|---|---|---|
| number | amount | date | name | location | type |
| T1 | $650.00 | Apr. 20, 2002 | Delta | Fairfax, VA | airline |
| T2 | $14.40 | Apr. 22, 2002 | Exxon | Fairfax, VA | gas |
| T3 | $980.00 | Apr. 23, 2002 | Rooms to | Fairfax, VA | furniture |
| | | | Go | | |
| T4 | $101.94 | Apr. 23, 2003 | Our Eyes | Atlanta, GA | eye care |
| T5 | $112.84 | Apr. 28, 2003 | Houston's | Atlanta, GA | restaurant |
| T6 | $44.03 | Apr. 28, 2003 | Home | Fairfax, VA | home |
| | | | Depot | | improvement |
| T7 | $6.00 | May 1, 2003 | Safeway | Washington, | coffee |
| | | | | DC | |
| T8 | $32.00 | May 2, 2002 | Home | Rockville, | home |
| | | | Depot | MD | improvement |
| T9 | $22.20 | May 8, 2002 | Safeway | Fairfax, VA | grocery |
| T10 | $123.99 | May 9, 2002 | Borders | Atlanta, GA | bookstore |
| T11 | $64.55 | May 11, 2002 | Tires Plus | Fairfax, VA | automotive |

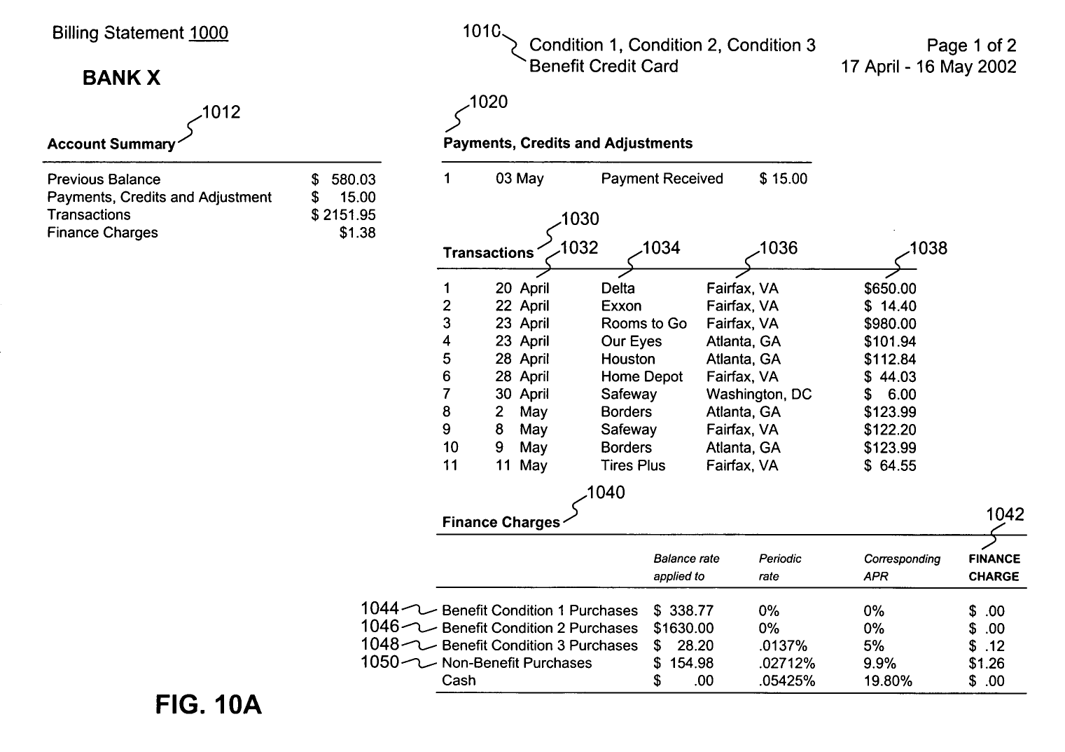

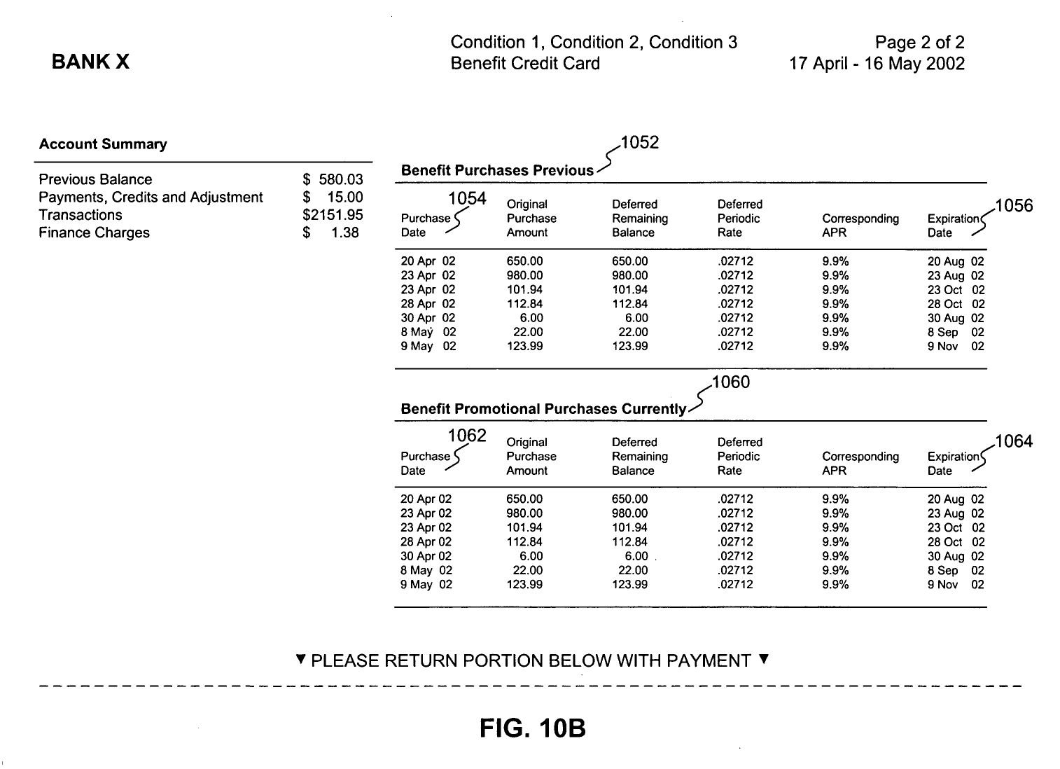

As the user performs each transaction (Step 700), the financial account provider 26 may perform a transaction match process (Step 710) where each purchase transaction is compared to each condition that the benefit credit card is associated with. After each purchase transaction is matched against each condition of the benefit credit card, the financial account provider 26 may perform a transaction expiration process (Step 720) to ensure that any transactions that have met the conditions of the benefit credit card previously do not have parameters that have not yet expired. Finally, at the end of the billing cycle, the financial account provider 26 may generate a statement for the user (Step 730). In one embodiment, the statement (FIGS. 10A and 10B) may but is not limited to include current balance, current purchase transaction, current amount due, and a break up of the purchase transactions that have satisfied account conditions and ones that are standard conditions.

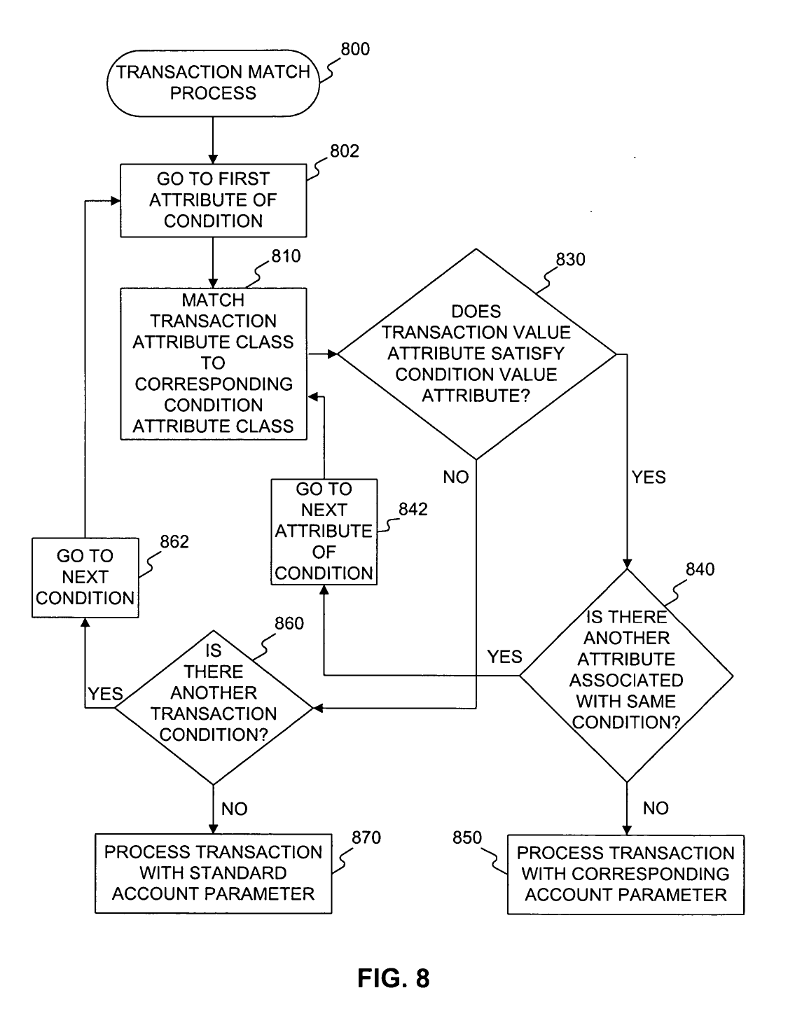

FIG. 8 illustrates a flowchart of an exemplary transaction match process for implementing step 710 of FIG. 7. As the user performs each purchase transaction with the benefit credit card account, the financial account provider 26 may compare each transaction with each condition that the benefit credit card is associated with. The financial account provider 26 compares the first attribute of the condition (Step: 802) with the transaction's class attribute and locate the corresponding transaction attribute class that matches the condition attribute class (Step 810). The financial account provider 26 may then compare the transaction value attribute with the condition value attribute and decides whether the transaction value attribute satisfies the condition value attribute (Step 830).

For exemplary purposes and only to illustrate embodiments of the transaction match process, reference will be made to Tables 1-4 shown above. After the user performs the first purchase transaction (T1), financial account provider 26 may compare all the transaction class attributes, in this case transaction amount, transaction date, merchant name, merchant location, and merchant type with the first condition class attribute. Referring to Table 1, the first condition class attribute is “transaction amount.” Once the financial account provider 26 matches the “transaction amount” class attribute of the transaction with the “transaction amount” class attribute of the condition, the financial account provider 26 next compares the transaction value attribute of the same transaction with the condition value attribute (Step 830). T1 has a transaction value attribute of $650.00 and when the financial account provider 26 compares this value with the attribute value of “>$599.00,” the financial account provider 26 determines that this attribute was satisfied.

After a transaction satisfies an attribute of a condition, financial account provider 26 may determine whether there is another attribute associated with the same condition (Step 840). If there is, the financial account provider 26 goes to the next attribute of the same condition (Step 842) and starts the transaction match process over again by comparing all the transaction class attributes with the condition's second attribute class and matching the transaction account class to the condition account class (Step 810). In this example, condition 1 has a second attribute. Financial account provider 26 compares all the transaction attribute classes with the condition attribute class “merchant location.” After the financial account provider 26 matches the class, it may then compare the transaction attribute value with the condition attribute value of the corresponding condition attribute class. In this example, the condition attribute value is “=Georgia.” T1 has a transaction attribute class of “transaction location” and the value associated with this transaction location is “Atlanta, Ga.” Financial account provider 26 may then consider this a match. After financial account provider 26 matches the second attribute of condition 1, it determines whether there is another attribute associated with condition 1. Condition 1 in Table 1 only has two attributes. After the financial account provider 26 determines that there are no more attributes associated with the condition, the financial account provider 26 processes the purchase transaction with the corresponding account parameter (Step 850).

If the first condition attribute value does not match any transaction attribute value, (Step 830; NO) financial account provider 26 may determine if the financial account has another condition associated with it (Step 860). If there is another condition, financial account provider 26 may compare and match the transaction class attributes with the next condition's class attribute (Step 810). If however, there are no more conditions (Step 860; No) financial account provider 26 may process the purchase transaction with a standard account parameter (Step 870). One skilled in the art would realize that the manner by which financial account provider 26 marches the purchase transactions to the conditions is not limited to the above examples, and other techniques may be implemented without departing from the spirit and scope of the present invention.

For example, after the user performs T2, financial account provider 26 may compare the transaction class attributes with the first condition class attribute. Financial account provider 26 finds a match for the class attribute “transaction amount,” however, there is no match for the value associated with the value attribute. Next the financial account provider 26 decides whether there is another condition associated with the account. In this example, condition 2 is also associated with the benefit card account. Financial account provider 26 compares the transaction class attribute with the class attribute of condition 2 (Step 810). The transaction attribute value for “transaction amount” for T2 is “$14.40” and the condition attribute value for “transaction amount” for condition 2 is “>$599.00.” Financial account provider 26 determines that this attribute is not satisfied. Financial account provider 26 next determines that the benefit credit card has a third condition associated with it and compares the transaction attribute class with the condition attribute class and determines that the condition attribute class “transaction period” matches the transaction attribute class for T2. Next the financial account provider 26 determines whether the transaction value attribute of that class satisfies the condition attribute value, and in this case, T2 has a “transaction time of “Apr. 22, 2002” which was not a Wednesday as stated in condition 3. Once the financial account provider 26 determines that the value is not satisfied, it determines whether there is another condition associated with the account (Step 840). In this example, the benefit credit card is only associated with condition 1, condition 2, and condition 3. Financial account provider 26 may then determine there are no more conditions associated with the benefit credit card and therefore it may process T2 with the standard account parameter.

Referring back to step 850, once the financial account provider 26 determines that a transaction has satisfied all the attributes of a condition, then the financial account provider 26 may process the transaction with the account parameter corresponding to the satisfied condition. For example, as previously described, T1 satisfied condition 2 of the benefit credit account. Therefore, financial account provider 26 may process T2 according to the account parameter corresponding to condition 2. As shown in Table 2, condition 2 has account parameters listed as “finance charge will be waived for 4 months.”

For exemplary purposes and only to illustrate embodiments of the transaction match process, financial account provider 26 may match up the transactions in Table 4 with the conditions of Tables 1-3 as displayed in Table 5.

TABLE 5
Exemplary Transactions

| Transaction | Transaction | Transaction | Merchant | Merchant | Merchant | condition |
|---|---|---|---|---|---|---|
| number | amount | date | name | location | type | satisfied |
| T1 | $650.00 | Apr. 20, | Delta | Fairfax, VA | airline | condition 2 |
| | | 2002 | | | | |
| T2 | $14.40 | Apr. 22, | Exxon | Fairfax, VA | gas | NONE |
| | | 2002 | | | | |
| T3 | $980.00 | Apr. 23, | Rooms to | Fairfax, VA | furniture | condition 2 |
| | | 2002 | Go | | | |
| T4 | $101.94 | Apr. 23, | Our Eyes | Atlanta, GA | eye care | condition 1 |
| | | 2002 | | | | |
| T5 | $112.84 | Apr. 28, | Houston's | Atlanta, GA | restaurant | condition 1 |
| | | 2002 | | | | |
| T6 | $44.03 | Apr. 28, | Home | Fairfax, VA | home | NONE |
| | | 2002 | Depot | | improvement | |
| T7 | $6.00 | May 1, 2002 | Safeway | Washington, | coffee | condition 3 |
| | | | | DC | | |
| T8 | $32.00 | May 2, 2002 | Home | Rockville, | home | NONE |
| | | | Depot | MD | improvement | |
| T9 | $22.20 | May 8, 2002 | Safeway | Fairfax, VA | grocery | condition 3 |
| T10 | $123.99 | May 9, 2002 | Borders | Atlanta, GA | bookstore | condition 1 |
| T11 | $64.55 | May 11, | Tires Plus | Fairfax, VA | automotive | NONE |
| | | 2002 | | | | |

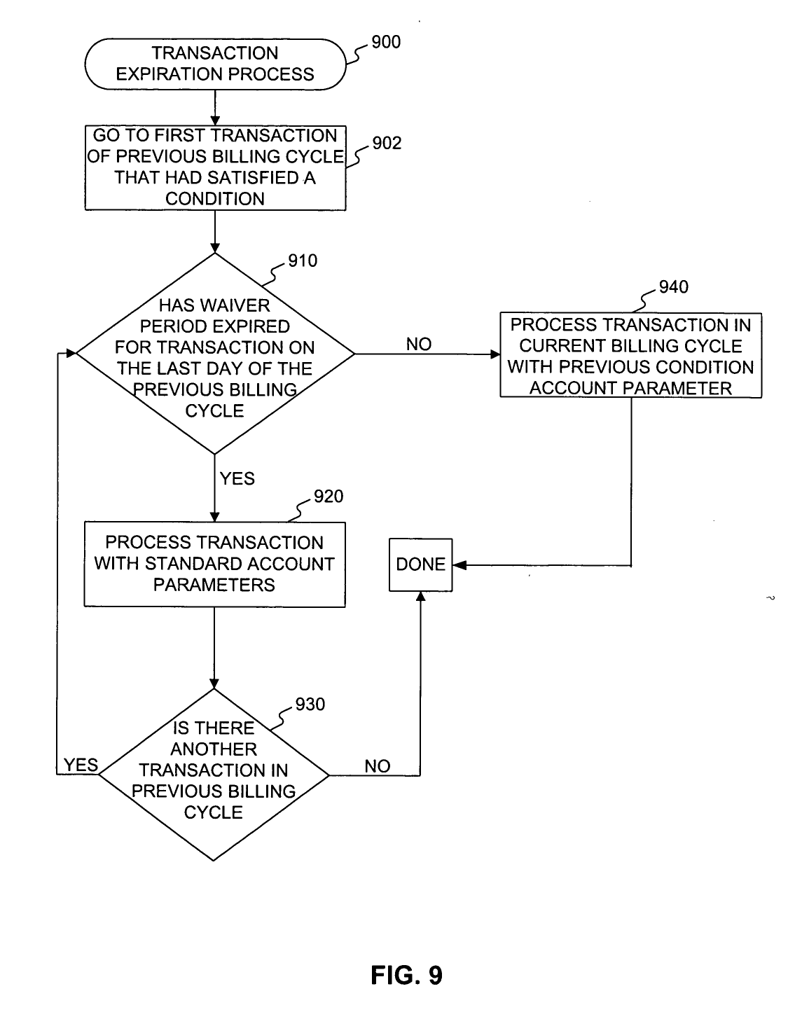

FIG. 9 illustrates a flowchart of an exemplary transaction expiration process for implementing step 720 of FIG. 7. After the financial account provider 26 processes the transactions for the current billing cycle, the financial account provider may determine whether previous transactions that were processed according to the conditions of the benefit credit card have parameter time periods that have expired, in order to determine what account parameters to apply for the transactions in the current statement. Financial account provider 26 may go to the first transaction of the previous billing cycle that had satisfied a condition associated with the credit account (Step 902). Financial account provider 26 may then determine whether the time period of the condition account parameter expired on the last day of the previous billing cycle (Step 910). If the time period did expire on the last day of the last billing cycle, the financial account provider 26 may process the transaction with the standard account parameters (Step 920) in the current billing cycle. The financial account provider 26 may then determine whether there is another transaction in the previous billing cycle that satisfied a condition (Step 930) and may determine whether the time period for this transaction has expired. If the time period for the condition account parameter has not expired, the financial account provider 26 may process the transaction in the current billing cycle with the same condition account parameter that the financial account provider 26 used in the previous billing cycle (Step 940).

In one exemplary configuration, the financial account provider 26 may determine whether the time period of the condition account parameter of the transaction will expire during the current billing cycle. If the time period will expire the financial account provider 26 may send a reminder to the customer letting them know that the time period for a condition account parameter related to a transaction will expire during the current billing cycle.

In another exemplary configuration, the financial account provider 26 may then determine whether the time period of the condition account parameter of the transaction will expire during the next billing cycle. If the time period will expire the financial account provider 26 may send a reminder to the customer letting them know that the time period for a condition account parameter related to a transaction will expire during the next billing cycle.

In another exemplary configuration, if the time period will expire during the current billing cycle, the financial account provider may extend the time period to the end of the current billing cycle and the transaction may not be processed with the standard account parameters until the next billing cycle. In yet another exemplary configuration, the financial account provider 26 may process the transactions from a previous billing cycle that has a condition account parameter that will expire during the current billing cycle by processing it from the first day of the current billing cycle to the day of the current billing cycle on which the time period will expire with the previous condition account parameter, and processing it from the day after of the expiration to the last day of the current billing cycle with a standard account parameter. In yet another exemplary configuration, the financial account provider 26 may process the transactions with a time period that expired at the end previous billing cycle with the second account parameter from a point after the end of the time period during the previous billing cycle until the transaction is paid. One skilled in the art would realize that the manner by which financial account provider determines how to process transactions that end in the middle of the billing cycle is not limited to the above examples, and other techniques may be implemented without departing from the spirit and scope of the present invention.

In yet another exemplary configuration, financial account provider 26 may rank the order of the conditions to compare against the purchase transactions. It then may process the transaction according to the account parameters of the last condition that the transaction satisfied therefore, even if the transaction satisfies all of the purchase conditions, the last condition that the transaction is compared against and satisfied is the condition used to process the transaction accordingly. For example, if T1 satisfies condition 1 and condition 2, financial account provider 16 may process the transaction according to the account parameters of condition 2 even though both conditions were satisfied.

FIGS. 10A and 10B represent an exemplary sample billing statement 1000 in accordance with the principles of the invention. The billing statement 1000 may reflect what conditions 1000 are associated with the Benefit Credit Card. The billing statement 1000 may provide an Account Summary 1012. The statement may further include Payment, Credits and Adjustments to the account 1020. Transactions 1030 may list all of the current transactions associated with the current billing cycle. Each transaction may have one or more attributes per transaction. In this example, each transaction has four attributes listed, date 1032, merchant name 1034, merchant location 1036, and transaction amount 1038. One skilled in the art will appreciate that any combination of attributes may be listed in a statement consistent with the present invention.

The billing statement 1000 may further list finance charge summary 1040 associated with the transactions of the account. The finance charge summary 1040 may list each benefit condition associated with the account and what purchases have satisfied that condition and what the finance charge is with each condition 1044, 1046, and 1048. The finance charge summary 1040 may further list non-benefit purchases 1050 and the finance charge that is due on those purchases.

Referring now to FIG. 10B, the billing statement 1000 may further list benefit purchases from previous billing cycles 1052. This summary section may list the purchase date 1054 of the previous purchases, and what the expiration date is on the account parameter time period associated with the condition 1056. The billing statement 1000 may also list the benefit promotional purchases 1060 that are current in the billing cycle. The purchase date 1062 and the expiration date of the account parameter time period 1064 may also be listed. The combinations of what a billing statement may reflect may extend beyond these examples, and one skilled in the art would realize that the present invention is not limited to the above billing statement example.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of managing a financial account comprising:
defining at least one condition for the financial account;
defining first and second account parameters, wherein the first account parameter is associated with the condition;
determining whether transactions associated with the financial account satisfy the condition;
processing transactions that satisfy the condition based on the first account parameter; and
processing other transactions based on the second account parameter.

2. The method of claim 1, wherein the condition and transactions each comprise at least one attribute, the attribute comprising an attribute class and an attribute value.

3. The method of claim 1, wherein the financial account is a credit card account.

4. The method of claim 1, wherein the first and second account parameters are a first and a second interest rate, respectively, wherein the first interest rate is lower than the second interest rate.

5. The method of claim 1, wherein the first and second account parameters are a first and a second interest rate, respectively, wherein the first interest rate is higher than the second interest rate.

6. The method of claim 1, wherein defining first and second account parameters further comprises:
defining at least one account parameter with at least one account parameter type and at least one account parameter time period, wherein the account parameter time period is associated with the account parameter type.

7. The method of claim 1, further comprising:
determining whether any transactions processed using the first account parameter in a previous billing cycle are associated with an account parameter time period that will expire during a next billing cycle; and
providing a financial account holder with a notification stating that the account parameter time period associated with the transaction will end during the next billing cycle based on the determining step.

8. The method of claim 1, further comprising:
determining whether any transactions processed using the first account parameter in a previous billing cycle are associated with an account parameter time period that expired at the end of the previous billing cycle; and
processing all transactions associated with the account parameter time period that expired at the end of the previous billing cycle with the second account parameter.

9. The method of claim 1, further comprising:
determining whether any transactions processed using the first account parameter in a previous billing cycle are associated with an account parameter time period that will expire at the end of a current billing cycle; and
processing all transactions associated with the account parameter time period that will expire at the end of the current billing with the first account parameter.

10. The method of claim 1, further comprising:
determining whether any transactions processed using the first account parameter in a previous billing cycle are associated with an account parameter time period that will expire during a current billing cycle; and
processing all transactions associated with the account parameter time period that will expire during the current billing with the first account parameter until the account parameter time period expires and with the second account parameter after the account parameter time period expires.

11. The method of claim 1, further comprising:
determining whether any transactions processed using the first account parameter in a previous billing cycle are associated with an account parameter time period that will expire during a current billing cycle; and
processing all transactions associated with the account parameter time period that will expire during the current billing with the first account parameter until the end of the current billing cycle.

12. The method of claim 1, further comprising:
generating a billing statement reflecting an amount to be paid by a financial account holder based on at least the first and second account parameters.

13. The method of claim 2, wherein the class is at least one of: a merchant name;
a merchant type; a merchant location; a transaction date; a transaction time; and a transaction amount.

14. The method of claim 2, wherein defining at least one condition for the financial account further comprises:
choosing the attribute class of the attribute;
choosing the attribute value of the attribute; and
setting the attribute class to either equal or be greater than the attribute value.

15. The method of claim 2, wherein determining whether transactions associated with the financial account satisfy the condition further comprises:
comparing each attribute of each transaction with each attribute of the condition; and
determining whether any attribute of the transaction satisfies each attribute of the condition.

16. The method of claim 6, wherein the account parameter type is at least one of:
an interest rate; a finance charge waiver period; a monthly payment waiver period; and a payment allocation.

17. The method of claim 6, further comprising:
applying the account parameter to transactions that satisfy the condition associated with the account parameter.

18. The method of claim 6, wherein the account parameter time period comprises more than one billing cycle.

19. The method of claim 15, further comprising:
comparing the transaction attribute class with the condition attribute class;
determining whether the transaction attribute class matches any condition attribute class; and
comparing the transaction attribute value with the condition attribute value based on the determining step.

20. A system for managing a financial account, comprising:
means for defining at least one condition for the financial account;
means for defining first and second account parameters, wherein the first account parameter is associated with the condition;
means for determining whether transactions associated with the financial account satisfy the condition;
means for processing transactions that satisfy the condition based on the first account parameter; and
means for processing other transactions based on the second account parameter.

21. The system of claim 20, wherein the condition and transactions each comprise at least one attribute, the attribute comprising an attribute class and an attribute value

22. The system of claim 20, wherein the financial account is a credit card account.

23. The system of claim 20, wherein the first and second account parameters are a first and a second interest rate, respectively, wherein the first interest rate is lower than the second interest rate.

24. The system of claim 20, wherein the first and second account parameters are a first and a second interest rate, respectively, wherein the first interest rate is higher than the second interest rate.

25. The system of claim 20, wherein defining first and second account parameters further comprises:
means for defining at least one account parameter with at least one account parameter type and at least one account parameter time period, wherein the account parameter time period is associated with the account parameter type.

26. The system of claim 20, further comprising:
means for determining whether any transactions processed using the first account parameter in a previous billing cycle are associated with an account parameter time period that will expire during a next billing cycle; and
means for providing a financial account holder with a notification stating that the account parameter time period associated with the transaction will end during the next billing cycle based on the determining step based on the determination made by the means for determining whether any transactions processed using the first account parameter in a previous billing cycle are associated with an account parameter time period that will expire during a next billing cycle.

27. The system of claim 20, further comprising:
means for determining whether any transactions processed using the first account parameter in a previous billing cycle are associated with an account parameter time period that expired at the end of the previous billing cycle; and
means for processing all transactions associated with the account parameter time period that expired at the end of the previous billing cycle with the second account parameter.

28. The system of claim 20, further comprising:
means for determining whether any transactions processed using the first account parameter in a previous billing cycle are associated with an account parameter time period that will expire at the end of a current billing cycle; and
means for processing all transactions associated with the account parameter time period that will expire at the end of the current billing with the first account parameter.

29. The system of claim 20, further comprising:
means for determining whether any transactions processed using the first account parameter in a previous billing cycle are associated with an account parameter time period that will expire during a current billing cycle; and
means for processing all transactions associated with the account parameter time period that will expire during the current billing with the first account parameter until the account parameter time period expires and with the second account parameter after the account parameter time period expires.

30. The system of claim 20, further comprising:
means for determining whether any transactions processed using the first account parameter in a previous billing cycle are associated with an account parameter time period that will expire during a current billing cycle; and
means for processing all transactions associated with the account parameter time period that will expire during the current billing with the first account parameter until the end of the current billing cycle.

31. The system of claim 20, further comprising:
means for generating a billing statement reflecting an amount to be paid by a financial account holder based on at least the first and second account parameters.

32. The system of claim 21, wherein the class is at least one of: a merchant name;
a merchant type; a merchant location; a transaction date; a transaction time; and a transaction amount.

33. The system of claim 21, wherein defining at least one condition for the financial account further comprises:
means for choosing the attribute class of the attribute;
means for choosing the attribute value of the attribute; and
means for setting the attribute class to either equal or be greater than the attribute value.

34. The system of claim 21, wherein determining whether transactions associated with the financial account satisfy the condition further comprises:
means for comparing each attribute of each transaction with each attribute of the condition; and
means for determining whether any attribute of the transaction satisfies each attribute of the condition.

35. The system of claim 25, wherein the account parameter type is at least one of:
an interest rate; a finance charge waiver period; a monthly payment waiver period; and a payment allocation.

36. The system of claim 25, further comprising:
means for applying the account parameter to transactions that satisfy the condition associated with the account parameter.

37. The system of claim 25, wherein the time period comprises more than one billing cycle.

38. The system of claim 34, further comprising:
means for comparing the transaction attribute class with the condition attribute class;
means for determining whether the transaction attribute class matches any condition attribute class; and
means for comparing the transaction attribute value with the condition attribute value based on the determination made by the means for determining whether the transaction attribute class matches any condition attribute class.

39. A computer-readable medium including instructions for performing a method, when executed by a processor, for managing a financial account, the method comprising:
defining at least one condition for the financial account;
defining first and second account parameters, wherein the first account parameter is associated with the condition;
determining whether transactions associated with the financial account satisfy the condition;
processing transactions that satisfy the condition based on the first account parameter; and
processing other transactions based on the second account parameter.

40. The computer-readable medium of claim 39, wherein the condition and transactions each comprise at least one attribute, the attribute comprising an attribute class and an attribute value.

41. The computer-readable medium of claim 39, wherein the financial account is a credit card account.

42. The computer-readable medium of claim 39, wherein the first and second account parameters are a first and a second interest rate, respectively, wherein the first interest rate is lower than the second interest rate.

43. The computer-readable medium of claim 39, wherein the first and second account parameters are a first and a second interest rate, respectively, wherein the first interest rate is higher than the second interest rate.

44. The computer-readable medium of claim 39, wherein defining first and second account parameters further comprises:
defining at least one account parameter with at least one account parameter type and at least one account parameter time period, wherein the account parameter time period is associated with the account parameter type.

45. The computer-readable medium of claim 39, wherein the method further comprises:
determining whether any transactions processed using the first account parameter in a previous billing cycle are associated with an account parameter time period that will expire during a next billing cycle; and
providing a financial account holder with a notification stating that the account parameter time period associated with the transaction that will end during the next billing cycle based on the determining step.

46. The computer-readable medium of claim 39, wherein the method further comprises:
determining whether any transactions processed using the first account parameter in a previous billing cycle are associated with an account parameter time period that expired at the end of the previous billing cycle; and
processing all transactions associated with the account parameter time period that expired at the end of the previous billing cycle with the second account parameter.

47. The computer-readable medium of claim 39, wherein the method further comprises:
determining whether any transactions processed using the first account parameter in a previous billing cycle are associated with an account parameter time period that will expire at the end of a current billing cycle; and
processing all transactions associated with the account parameter time period that will expire at the end of the current billing with the first account parameter.

48. The computer-readable medium of claim 39, wherein the method further comprises:
determining whether any transactions processed using the first account parameter in a previous billing cycle are associated with an account parameter time period that will expire during a current billing cycle; and
processing all transactions associated with the account parameter time period that will expire during the current billing with the first account parameter until the account parameter time period expires and with the second account parameter after the account parameter time period expires.

49. The computer-readable medium of claim 39, wherein the method further comprises:
determining whether any transactions processed using the first account parameter in a previous billing cycle are associated with an account parameter time period that will expire during a current billing cycle; and
processing all transactions associated with the account parameter time period that will expire during the current billing with the first account parameter until the end of the current billing cycle.

50. The computer-readable medium of claim 39, wherein the method further comprises:
generating a billing statement reflecting an amount to be paid by a financial account holder based on at least the first and second account parameters.

51. The computer-readable medium of claim 40, wherein the class is at least one of: a merchant name; a merchant type; a merchant location; a transaction date; a transaction time; and a transaction amount.

52. The computer-readable medium of claim 40, wherein defining at least one condition for the financial account further comprises:
choosing the attribute class of the attribute;
choosing the attribute value of the attribute; and
setting the attribute class to either equal or be greater than the attribute value.

53. The computer-readable medium of claim 40, wherein determining whether transactions associated with the financial account satisfy the condition further comprises:
comparing each attribute of each transaction with each attribute of the condition; and
determining whether any attribute of the transaction satisfies each attribute of the condition.

54. The computer-readable medium of claim 44, wherein the account parameter type is at least one of: an interest rate; a finance charge waiver period; a monthly payment waiver period; and a payment allocation.

55. The computer-readable medium of claim 44, wherein the method further comprises:
applying the account parameter to transactions that satisfy the condition associated with the account parameter.

56. The computer-readable medium of claim 44, wherein the account parameter time period comprises more than one billing cycle.

57. The computer-readable medium of claim 53, further comprising:
comparing the transaction attribute class with the condition attribute class;
determining whether the transaction attribute class matches any condition attribute class; and
comparing the transaction attribute value with the condition attribute value based on the determining step.

58. A method of setting up a condition for a financial account, wherein the condition comprises of at least one attribute, comprising:
choosing a class and a value of the attribute;
assigning the attribute to the condition;
determining whether to set up another attribute; and
setting up account parameters associated with the condition based on the determining step.

59. A method of defining an account parameter for a financial account, wherein the account parameter is associated with a condition, comprising:
determining a type of account parameter to associate with the condition;
selecting a time period to associate with the type of account parameter; and
assigning the account parameter to the condition.

60. A method of managing a financial account, wherein the financial account is associated with at least one condition, the condition comprising at least one attribute, comprising:
collecting transaction information from a financial account user, wherein the transaction comprises at least one attribute;
comparing each attribute of each transaction with each attribute of the condition;
determining whether any attribute of the transaction satisfies each attribute of the condition; and
processing the transaction with an account parameter based on the determining step.
